(19) United States
(12) Patent Application Publication
(10) Pub. No.: US 2026/0024295 A1
(43) Pub. Date: Jan. 22, 2026

(54) TARGET VIRTUAL OBJECT CONTROL METHOD AND ELECTRONIC DEVICE

(71) Applicant: Lenovo (Beijing) Limited, Beijing (CN)

(72) Inventor: Nianlong LI, Beijing (CN)

(21) Appl. No.: 19/269,790

(22) Filed: Jul. 15, 2025

(30) Foreign Application Priority Data
Jul. 16, 2024 (CN) 202410954064.9

(51) Int. Cl. G06T 19/20; G06V 40/20

(52) U.S. Cl. CPC G06T 19/20; G06V 40/28; G06T 2219/2004; G06T 2219/2016

(57) ABSTRACT

A target virtual object control method includes: in response to determining an existence of a target virtual object in a target interactive interface, identifying a user's gesture action; in response to determining the gesture action is a predetermined action formed between a user's hand and a physical object and satisfies a predetermined time condition, associating the target virtual object with the physical object; and according to the association result and the user's operation behavior on the physical object, driving the target virtual object.

### RELATED APPLICATION(S)

This application claims priority to Chinese Patent Application No. 202410954064.9 filed with the China National Intellectual Property Administration (CNIPA) on Jul. 16, 2024, which is incorporated herein by reference in entirety.

### FIELD OF THE TECHNOLOGY

The present disclosure relates to the field of computer virtual reality technology, and in particular to a target virtual object control method and an electronic device.

### BACKGROUND

Manipulating 3D objects in space may be a basic task. In the glasses-free 3D red dot project, one of the tasks is to demonstrate the user's ability to manipulate models with gestures. One existing solution may be to rotate the target virtual object by pinching in the air. However, due to the remote operation and the lack of gripping touch feel, one can only rely on spatial imagination to construct a rotation anchor point in mind, resulting in the actual rotation position not meeting one's expectations.

### SUMMARY

In one aspect, the present disclosure provides a target virtual object control method. The target virtual object control method includes: in response to determining a target virtual object existing in a target interactive interface, identifying a user's gesture action; in response to determining the gesture action is a predetermined action formed between a user's hand and a physical object and satisfies a predetermined time condition, associating the target virtual object with the physical object; and driving the target virtual object based on the association result and the user's operation behavior on the physical object.

In another aspect, the present disclosure provides an electronic device. The electronic device includes: a memory storing computer program instructions; and a processor coupled to the memory and configured to execute the computer program instructions and perform: in response to determining a target virtual object existing in a target interactive interface, identifying a user's gesture action; in response to determining the gesture action is a predetermined action formed between a user's hand and a physical object and satisfies a predetermined time condition, associating the target virtual object with the physical object; and driving the target virtual object based on the association result and the user's operation behavior on the physical object,.

In yet another aspect, the present disclosure provides a non-transitory computer-readable storage medium storing computer program instructions executable by at least one processor to perform: in response to determining a target virtual object existing in a target interactive interface, identifying a user's gesture action; in response to determining the gesture action is a predetermined action formed between a user's hand and a physical object and satisfies a predetermined time condition, associating the target virtual object with the physical object; and driving the target virtual object based on the association result and the user's operation behavior on the physical object.

The target virtual object control method and electronic device according to certain embodiments of the present disclosure present the target virtual object through the target interactive interface, and monitor and identify the gesture action existing in the target interactive interface in real time, and when the gesture action is detected to be a predetermined action between the user's hand and the physical object, the target virtual object is associated with the physical object, so that the user's operation action on the physical object may be applied to the target virtual object, and that the target virtual object moves with the movement of the physical object.

The content described in this section is not intended to necessarily identify any key or important features of the embodiments of the present disclosure, nor is it used to limit the scope of the present disclosure. Other features of the present disclosure will become easy to understand through the following description.

### BRIEF DESCRIPTION OF THE DRAWINGS

By reading the detailed description herein in reference to the accompanying drawings, features and advantages of certain embodiments of the present disclosure become easier to understand. In the accompanying drawings, several embodiments of the present disclosure are shown in a non-restrictive manner, where:

In the accompanying drawings, the same or corresponding reference numerals represent the same or corresponding parts.

FIG. 1 shows a schematic diagram of an implementation process of the target virtual object control method in certain embodiments of the present disclosure;

FIG. 2 shows a schematic diagram of an implementation process of the target virtual object control method in certain embodiments of the present disclosure;

FIG. 3 shows a schematic diagram of an implementation process of the target virtual object control method in certain embodiments of the present disclosure;

FIG. 4 shows a schematic diagram of the structure of the target virtual object control device in certain embodiments of the present disclosure; and

FIG. 5 shows a schematic diagram of a composition structure of an electronic device in certain embodiments of the present disclosure.

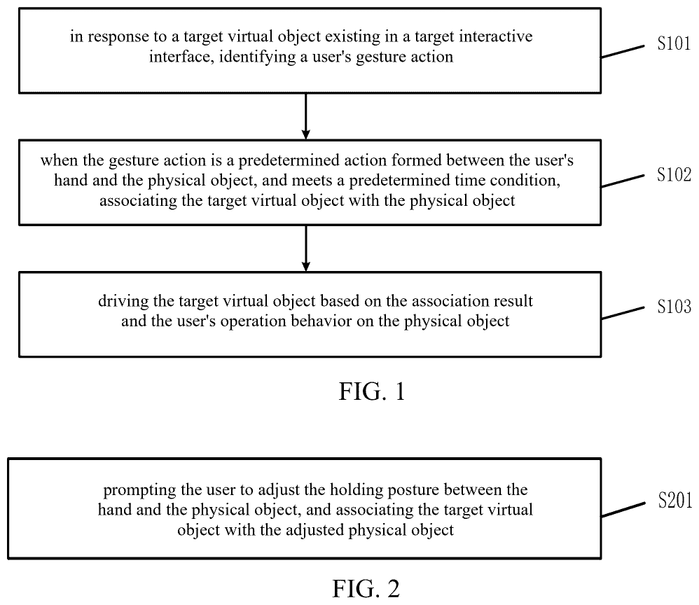

### DETAILED DESCRIPTION

In order to make the purpose, features, and advantages of certain embodiments of the present disclosure easier to understand, the technical solutions in the embodiments of the present disclosure are described below in conjunction with the drawings. The embodiments described are only part of possible embodiments of the present disclosure, but not all of the possible embodiments. Based on the embodiments in the present disclosure, other embodiments obtained by those skilled in the technical field without creative work are within the scope of protection of the present disclosure.

The following describes a target virtual object control method provided according to certain embodiments of the present disclosure in conjunction with the accompanying drawings, the method including:

S101, in response to a target virtual object existing in a target interactive interface, identifying a user's gesture action.

Certain embodiments of the present disclosure describe an electronic device used to implement the target virtual object control method. The electronic device provided in certain embodiments of the present disclosure may be an intelligent terminal or a server. For example, the intelligent terminal may be a laptop, a tablet computer, a desktop computer, a smart phone, a dedicated messaging device, a portable gaming device, a smart speaker, a smart watch, or the like. The type of intelligent terminal is not limited in the present disclosure. The server may be an independent physical server, or a server cluster or distributed system composed of multiple physical servers, or a cloud server that provides cloud services, cloud databases, cloud computing, cloud functions, cloud storage, network services, cloud communications, middleware services, domain name services, security services, content distribution network (CDN, Content Delivery Network) services, and basic cloud computing services such as big data and artificial intelligence platforms.

In certain embodiments, when the electronic device recognizes the user's gesture, the user's gesture is within the target interaction interface, that is, the electronic device only recognizes the gesture within the target interaction interface to avoid wasting resources. In certain embodiments of the present disclosure, the electronic device collects gesture information within the target interaction interface in real time to avoid omissions when gestures occur. Among them, the target virtual object refers to a virtual object in a virtual reality scene. In certain embodiments, the gesture is any movement of the user's hand after the user's hand is detected.

Taking the electronic device as a computer as an example; for example, when the computer is turned on and receives the user's operation instruction, the target virtual object is presented in the target interaction interface according to the operation instruction, and the target interaction interface is monitored in real time to see whether there is a user's gesture action.

S102, when the gesture action is a predetermined action formed between the user's hand and the physical object, and meets a predetermined time condition, associating the target virtual object with the physical object.

Certain embodiments of the present disclosure preset a predetermined action between the user's hand and the physical object in the electronic device, and when the predetermined action is maintained for a certain period of time, the electronic device generates a control signal to associate the target virtual object with the physical object, and after the association, the target virtual object is mapped as an associated object of the physical object in the virtual environment.

In certain embodiments, the predetermined action between the hand and the physical object is an action of a finger holding the physical object, a palm holding the physical object, or a finger overhanging the physical object, or other predetermined actions, which is set according to the user's intentions.

The physical object in certain embodiments of the present disclosure is any physical object, which may be a cup, a mouse, a bottle, a book, or the like. In certain embodiments, when the electronic device recognizes that the user's hand is grabbing a cup, holding up a mouse, or overhanging a bottle, or other predetermined actions, the electronic device determines whether the predetermined action reaches a certain time period. If the predetermined action reaches a certain time period, it means that the predetermined action meets the predetermined time condition, and the target virtual object is mapped as an associated object of the physical object in the virtual environment.

S103, driving the target virtual object according to the association result and the user's operation behavior on the physical object.

In certain embodiments, after the target virtual object is associated with the physical object, the electronic device drives the target virtual object to move according to the user's operation on the physical object.

In the target interaction interface, taking the physical object as a water cup and the predetermined action as grabbing as an example, when the user grabs the water cup and rotates it at a certain angle, the target virtual object also rotates at the same angle. When the user grabs the water cup and moves it up and down a certain distance, the target virtual object also moves the same distance. In certain embodiments, the speed at which the target virtual object rotates or moves is the same as the speed at which the physical object rotates or moves. This makes the user's operation of the target virtual object more realistic and in line with expectations.

In certain embodiments, the term “the same” refers to a value plus or minus an error window, and the “error window” refers to a statistically allowable window of error. For example, a value of 5 plus or minus 0.1 is considered the same to the value of 5.

The target virtual object control method provided by certain embodiments of the present disclosure presents the target virtual object through a target interaction interface, and monitors and identifies gesture actions existing in the target interaction interface in real time. When it is detected that the gesture action is a predetermined action between the user's hand and the physical object, the target virtual object is associated with the physical object, so that the user's operation action on the physical object is applied to the target virtual object, the target virtual object moves with the physical object, the user drives the target virtual object by operating the physical object, so that the movement of the target virtual object meets the user's intentions, and the operation method is simple and convenient.

In certain embodiments, the physical object in the present disclosure is any physical object, and the user operates the target virtual object by operating any physical object around the user, which not only helps achieve simple operation but also gives the user an enhanced sense of reality when the user is operating the target virtual object.

In certain embodiments, the recognition of the user's gesture action includes at least one of the following:

Analyzing action information related to the user's hand and the physical object in the acquired video data to determine the user's gesture action; the video data may be collected by a camera.

Acquiring the posture change data of the user's hand, and determining the user's gesture action based on the posture change data; the posture change data may be collected by an inertial sensor.

In certain embodiments of the present disclosure, the user's gesture is identified by visual recognition, or by collecting gesture position data through an inertial sensor.

In certain embodiments, the visual recognition method is implemented by a camera, and the camera may be an electronic device belonging to the target virtual object control method of the present disclosure, such as a camera built into the electronic device; or the electronic device may be an electronic device that does not belong to the target virtual object control method of the present disclosure, such as an electronic device connected to the camera via a data cable. The camera collects video data of the target interactive interface and sends it to the electronic device. The built-in processing program of the electronic device analyzes the motion information of the user's hand and the physical object in the acquired video data, thereby identifying the user's gestures.

In certain embodiments, when there is a target virtual object in the target interactive interface, the processing program obtains the video data collected by the camera, and analyzes the action information of the user's hand and the physical object in the video data.

In certain embodiments, the user sets the inertial sensor on an ornament and then wears the ornament on the finger, so that the inertial sensor obtains the acceleration change of the hand in real time, thereby obtaining the position change of the user's hand, and the user's gesture action is recognized according to the position change. In certain embodiments, the inertial sensor is installed on a ring, and the user wears the ring on the hand.

Certain embodiments of the present disclosure use a camera and an inertial sensor. When the camera does not capture a gesture due to spatial position, the inertial sensor is used to collect the position change of the hand, thereby identifying the user's gesture. In certain embodiments, when the inertial sensor signal is unstable, the camera is used to collect video data so that the electronic device recognizes the user's gesture through the video data.

In certain embodiments, when the user grabs a cup, the inertial sensor worn on the hand recognizes the user's grabbing action based on the change in acceleration.

In certain embodiments, the predetermined action includes at least one of the following:
Grabbing, holding, lifting, sliding, hanging, pushing, and/or hitting.

In certain embodiments, the predetermined time condition includes at least one of the following:
The predetermined action recognition results in multiple consecutive video frames are the same within a predetermined time; and/or

The inertial signal obtained within the preset time remains stable.

In certain embodiments, the predetermined action is preset in the electronic device according to certain intentions of the user, and/or according to the volume, weight, or the like of the physical object.

In certain embodiments, when the user finds objects of relatively small weight and volume around him, such as a mouse, the user sets the predetermined action to lifting or grabbing, then lifting the mouse or grabbing the mouse forms the predetermined action; when the user finds an object of relatively moderate volume and weight to be placed in his hand, such as a cup, the user sets the predetermined action to grabbing, then grabbing the cup forms the predetermined action; when the user finds objects of relatively heavy weight and volume around him, such as a kettle, the user sets the predetermined action to pushing, then pushing the kettle forms the predetermined action.

In certain embodiments of the present disclosure, it is determined that the user wants to associate the target virtual object with the physical object after a predetermined action is formed for a certain period of time.

In certain embodiments, when a camera is used for visual recognition, when the predetermined action recognition results in multiple consecutive video frame images are the same within a preset time, it is considered that the predetermined action meets the predetermined time condition; or when the inertial signal obtained within the preset time remains stable, it is determined that the predetermined time condition is met.

In certain embodiments, associating the target virtual object with the physical object includes:
respectively obtaining the first posture data of the physical object and the second posture data of the target virtual object;
establishing a mapping relationship between the physical object and the target virtual object based on the first posture data and the second posture data;
based on the mapping relationship, mapping the target virtual object as an associated object of the physical object in the virtual environment.

In certain embodiments, posture data refers to the position and posture information of an object, which is usually expressed as posture (position and rotation angle), that is, (x, y, θ), which includes the position information of the object in three-dimensional space and the orientation or rotation angle information. In certain embodiments, the position information of the physical object includes the first spatial coordinates of the physical object, and the second posture coordinates of the target virtual object include the second spatial coordinates of the target virtual object; in certain embodiments, the first spatial coordinates of an outer contour of the physical object are determined, the second spatial coordinates of an outer contour of the target virtual object are determined, and a mapping relationship between the first spatial coordinates of the physical object and the second spatial coordinates of the target virtual object is established, as well as a mapping relationship between the rotation angle of the first spatial coordinate and the rotation angle of the second spatial coordinate, so that the target virtual object is mapped as an associated object of the physical object in the virtual environment.

In certain embodiments, the method includes determining the first spatial coordinates of the feature points of the outer contour of the physical object, and determining the second spatial coordinates of the feature points of the outer contour of the target virtual object. The feature points may be the center point of the leftmost contour of the outer contour, the center point of the rightmost contour of the outer contour, or other feature points. In certain embodiments, the method includes establishing a mapping relationship between the first spatial coordinates of the center point of the leftmost contour of the outer contour of the physical object and the second spatial coordinates of the center point of the leftmost contour of the outer contour of the target virtual object, as well as a mapping relationship between the first spatial coordinate rotation angle and the second spatial coordinate rotation angle, so that the target virtual object is mapped as an associated object of the physical object in the virtual environment. In certain embodiments, the method includes establishing a mapping relationship between multiple feature points of the physical object and multiple feature points at corresponding positions of the target virtual object, as well as a mapping relationship between the rotation angles of multiple feature points, so as to make the mapping relationship between the physical object and the target virtual object more accurate.

In certain embodiments, the step of driving the target virtual object according to the association result and the user's operation on the physical object includes:
obtaining the motion offset generated by the user's operation on the physical object;
driving the target virtual object to move according to the motion offset based on the association result.

In certain embodiments, after the physical object is associated with the virtual object, the user operates the physical object to make the physical object move, so that the target virtual object also moves accordingly because of the association.

In certain embodiments, when the user operates the cup to rotate a certain angle in one direction, the target virtual object also rotates in the same direction by the same angle, or when the user grabs the cup and moves it upward a certain distance, the target virtual object also moves upward by the same distance. When the real object is operated on, the behavior is mapped to the target virtual object, so that the user's operation on the target virtual object is more in line with the user's intentions.

In certain embodiments, the user's operation on the physical object includes at least one of the following:
rotating and/or sliding.

The motion offset includes at least one of the following:
three-axis rotation angle information of the user's gesture;
three-axis rotation angle information of the physical object; and/or
rotation angle change information of the target virtual object relative to the starting moment.

In certain embodiments, the user rotates the physical object, slides on the surface of the physical object, and/or conducts other operations. When the user's operation behavior on the physical object is identified by visual recognition, and when the user rotates the physical object, the electronic device system obtains the three-axis rotation angle information of the user gesture generated when the user rotates the physical object or the three-axis rotation angle information of the physical object. When the user's operation behavior on the physical object is collected by an inertial sensor, the system records the current moment as the starting moment, and the rotation angle of the target virtual object at the starting moment as the starting angle. When the physical object is operated to rotate, the rotation angle change information of the target virtual object relative to the starting moment is recorded and applied to the target virtual object. For sliding operations, when the user slides on the surface of the physical object, whether it is visual recognition or inertial sensor recognition, it is determined that the finger has slid on the surface of the physical object by collecting the motion trajectory of the fingertip or discrete sliding events. In certain embodiments, the system presets the operation change of the target virtual object corresponding to the sliding on the surface of the physical object. In certain embodiments, sliding toward the left or lower side relative to the surface of the physical object shrinks the target virtual object, and sliding toward the right or upper side relative to the surface of the physical object enlarges the target virtual object.

In certain embodiments, when an electronic device has a camera, the camera acquires video data, and the electronic device system analyzes the video data to acquire the three-axis rotation angle information of the user's gesture or the three-axis rotation angle information of a physical object such as a water cup. In certain embodiments, the three-axis rotation angle information of the user's gesture is the same as the three-axis rotation angle information of the water cup, and therefore, acquiring the three-axis rotation angle information of the user's gesture or the three-axis rotation angle information of the physical object has the same effect. When the user wears a ring with an inertial sensor, after recognizing the predetermined action, the electronic device system records the current moment as the starting moment, and the rotation angle of the water cup from this moment as the starting angle. After the water cup rotates, the rotation angle change information of the water cup relative to the target virtual object at the starting moment is determined, and the target virtual object is driven according to the rotation angle change information.

In certain embodiments, when the user wants to enlarge or reduce the target virtual object, the user slides the fingertip on the surface of the water cup to change the size of the target virtual object. In certain embodiments, sliding toward the left or lower side relative to the surface of the water cup reduces or enlarges the target virtual object, and sliding toward the right or upper side relative to the surface of the water cup enlarges or reduces the target virtual object, respectively. For the user's sliding operation to achieve the size change of the target virtual object, corresponding settings may be made according to the user's intentions, and the present disclosure does not limit the type of settings that may be made here.

In certain embodiments, the user's operation behavior on the physical object includes:
Determining a touch via the inertial sensor; to generate a preset instruction, the preset instruction is applied to use the current moment as the starting moment and determine the rotation angle of the current target virtual object as the starting rotation angle.

In certain embodiments, when using the inertial sensor to identify the user's gesture action, when the gesture action is already a predetermined action formed between the user's hand and the physical object, and the target virtual object is associated with the physical object, as the user's action changes, the target virtual object may be driven to change without the user's knowledge. In certain embodiments, when the gesture action is a predetermined action formed between the user's hand and the physical object, and the predetermined time conditions are met, the electronic device prompts the user as to whether to associate the target virtual object with the physical object, the user may touch the inertial sensor to generate a preset instruction, which is to associate the target virtual object with the physical object. At this time, the system may use the current moment as the starting moment and determine the rotation angle of the current target virtual object as the starting rotation angle.

In certain embodiments, after the user grabs the water cup by wearing a ring with an inertial sensor, when the inertial signal of the inertial sensor is stable within a certain period of time, the system displays a prompt message, such as whether to associate the physical object with the target virtual object. When the user determines to operate the target virtual object, a preset instruction is generated by touching the inertial sensor once or twice. After receiving the preset instruction, the system associates the water cup with the target virtual object and records the current time and the current rotation angle of the target virtual object. When the user operates the water cup to rotate, the target virtual object rotates the water cup by the rotation angle based on the current rotation angle.

In certain embodiments, as shown in FIG. 2, when the gesture action is a predetermined action formed between the user's hand and the physical object and satisfies the predetermined time conditions, the method includes:

S201, prompting the user to adjust the holding posture between the hand and the physical object, and associating the target virtual object with the adjusted physical object.

In certain embodiments, after the gesture action is a predetermined action formed between the user's hand and the physical object and meets the predetermined time conditions, the electronic device prompts the user to adjust the holding posture, and the user adjusts to a comfortable posture as the starting posture, and generates a preset instruction by touching the inertial sensor. After receiving the preset instruction, the system associates the physical object with the target virtual object, or the electronic device automatically associates the physical object with the target virtual object after a certain period of time after prompting the user to adjust the holding posture.

In certain embodiments, after the user grabs the water cup and reaches a predetermined time, the electronic device displays a message asking the user to adjust the holding posture. After receiving the prompt, the user adjusts the holding posture. After the adjustment, the preset instruction is generated by touching the inertial sensor, and the electronic device receives the preset association of the water cup and the target virtual object; after the electronic device displays a message asking the user to adjust the holding posture for a certain time, the water cup and the target virtual object are directly associated.

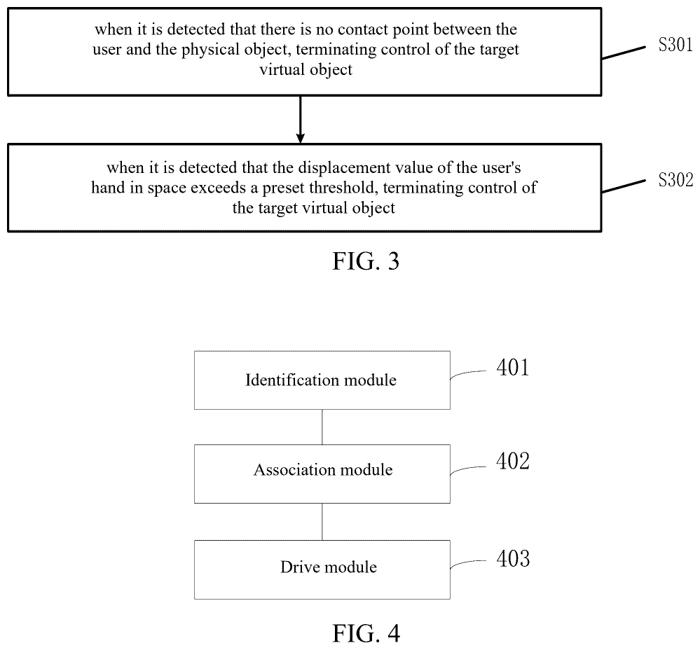

In certain embodiments, as shown in FIG. 3, after the target virtual object is driven according to the association result and the user's operation behavior on the physical object, the method includes:

S301, when it is detected that there is no contact point between the user and the physical object, the control of the target virtual object is terminated; or

S302, when it is detected that the displacement value of the user's hand in space exceeds a preset threshold, the control of the target virtual object is terminated.

In certain embodiments, after the user has finished operating the target virtual object, the physical object is put down during visual recognition; or when an inertial sensor is used, when the user's hand displacement in space exceeds a certain threshold and there is a letting-go-of-the-hand action, it is determined that the user has put down the object, and at this time, the association between the physical object and the target virtual object is terminated, and the control of the target virtual object is terminated.

In certain embodiments, when the electronic device has a camera, the user puts down the cup in his hand when he wants to end the operation of the target virtual object. After analyzing that the user has put down the cup, the electronic device disconnects the cup from the target virtual object. When the user wears a ring with an inertial sensor, the user directly moves the hand wearing the ring in the air for a certain distance. When the distance is greater than a preset threshold and there is a change in posture of letting go, the electronic device determines that the user has put down the cup, and disconnects the cup from the target virtual object.

As shown in FIG. 4, certain embodiments of the present disclosure provide a target virtual object control device, the device including:

Identification module 401, used to identify the user's gesture action in response to the presence of the target virtual object in the target interactive interface;

Association module 402, used to associate the target virtual object with the physical object when the gesture action is a predetermined action formed between the user's hand and the physical object and meets the predetermined time condition;

Drive module 403, used to drive the target virtual object according to the association result and the user's operation behavior on the physical object.

In the target virtual object control device provided by certain embodiments of the present disclosure, the identification module 401 responds to the target virtual object, recognizes the user's gesture action, the association module 402 associates the target virtual object with the physical object when the user's gesture action is a predetermined action between the user's hand and the physical object and meets the time condition, and the drive module 403 drives the target virtual object to perform corresponding actions according to the association result and the user's operation behavior on the physical object.

In certain embodiments, the identification module 401 includes at least one of the following:

An analysis unit is used to analyze the action information related to the user's hand and the physical object in the acquired video data to determine the user's gesture action; the video data is collected by a camera;

The first acquisition unit is used to obtain the posture change data of the user's hand, and determine the user's gesture action based on the posture change data; the posture change data is collected by an inertial sensor.

In certain embodiments, the predetermined action includes at least one of the following:
Grasping, holding, lifting, sliding, hanging, pushing, and/or hitting.

The predetermined time condition is met, including at least one of the following:
The predetermined action recognition results in multiple consecutive video frame images within a preset time are the same; and/or

The inertial signal obtained within the preset time remains stable.

In certain embodiments, the association module 402 includes:
A second acquisition unit, used to respectively acquire the first posture data of the physical object and the second posture data of the target virtual object;
An establishment unit, used to establish a mapping relationship between the physical object and the target virtual object based on the first posture data and the second posture data;
A mapping unit, used to map the target virtual object as an associated object of the physical object in the virtual environment based on the mapping relationship.

In certain embodiments, the drive module 403 includes:
A third acquisition unit, used to acquire the motion offset generated by the user's operation behavior on the physical object;
A drive unit, used to drive the target virtual object to move and change according to the motion offset based on the association result.

In certain embodiments, the user's operation behavior on the physical object includes at least one of the following:
Rotating and/or sliding;
The motion offset includes at least one of the following:
Three-axis rotation angle information of the user's gesture;
Three-axis rotation angle information of the physical object; and/or
Information on the rotation angle change of the target virtual object relative to the starting moment.

In certain embodiments, the user's operation behavior on the physical object includes:
A determination unit, used to touch the inertial sensor; to generate a preset instruction, the preset instruction is used to take the current moment as the starting moment and determine the rotation angle of the current target virtual object as the starting rotation angle.

In certain embodiments, when the gesture action is a predetermined action formed between the user's hand and the physical object and meets the predetermined time conditions,

Further included is a prompt module, used to prompt the user to adjust the holding posture between the hand and the physical object, and associate the target virtual object with the adjusted physical object.

In certain embodiments, after driving the target virtual object according to the association result and the user's operation behavior on the physical object,

Further included is a termination module, which is used to end the control of the target virtual object when it is detected that there is no contact point between the user and the physical object; or
When it is detected that the displacement value of the user's hand in space exceeds a preset threshold, the control of the target virtual object is ended.

In certain embodiments, the present disclosure provides an electronic device and a readable storage medium.

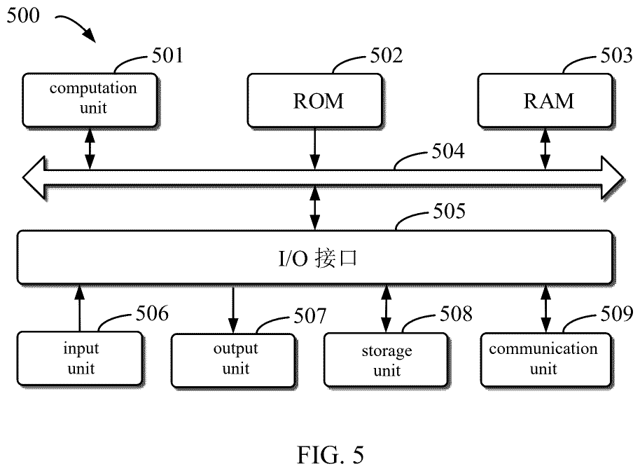

FIG. 5 shows a schematic block diagram of an electronic device 500 that is used to implement certain embodiments of the present disclosure. The electronic device represents various forms of digital computers, such as laptop computers, desktop computers, workstations, personal digital assistants, servers, blade servers, mainframe computers, and other suitable computers. The electronic device may also represent various forms of mobile devices, such as personal digital processing, cellular phones, smart phones, wearable devices, and other similar computing devices. The components shown herein, their connections and relationships, and their functions are merely examples and are not intended to limit the implementation of the present disclosure described and/or required herein.

As shown in FIG. 5, the device 500 includes a computation unit 501, which performs various appropriate actions and processes according to a computer program stored in a read-only memory (ROM) 502 or a computer program loaded from a storage unit 508 into a random access memory (RAM) 503. In the RAM 503, various programs and data desirable for the operation of the device 500 are stored. The computation unit 501, the ROM 502, and the RAM 503 are connected to each other via a bus 504. An input/output (I/O) interface 505 is connected to the bus 504.

A number of components in the device 500 are connected to the I/O interface 505, including: an input unit 506, such as a keyboard, a mouse, or the like; an output unit 507, such as various types of displays, speakers, or the like; a storage unit 508, such as a disk, an optical disk, or the like; and a communication unit 509, such as a network card, a modem, a wireless communication transceiver, or the like. The communication unit 509 allows the device 500 to exchange information/data with other devices through a computer network such as the Internet and/or various telecommunication networks.

The computation unit 501 may be a variety of general and/or special processing components with processing and computing capabilities. Some examples of the computation unit 501 include, but are not limited to, a central processing unit (CPU), a graphics processing unit (GPU), various dedicated artificial intelligence (AI) computing chips, various computing units running machine learning model algorithms, digital signal processors (DSPs), and any appropriate processors, controllers, microcontrollers, or the like. The computation unit 501 performs the various methods and processes described herein, such as the target virtual object control method. In certain embodiments, the target virtual object control method may be implemented as a computer software program, which is tangibly contained in a machine-readable medium, such as a storage unit 508. In certain embodiments, part or all of the computer program may be loaded and/or installed on the device 500 via the ROM 502 and/or the communication unit 509. When the computer program is loaded into the RAM 503 and executed by the computation unit 501, one or more steps of the target virtual object control method described herein may be performed. In certain embodiments, the computation unit 501 may be configured to execute the target virtual object control method in any other appropriate manner (for example, by means of firmware).

Various implementations of the systems and techniques described herein may be implemented in digital electronic circuit systems, integrated circuit systems, field programmable gate arrays (FPGAs), application specific integrated circuits (ASICs), application specific standard products (ASSPs), systems on chips (SOCs), complex programmable logic devices (CPLDs), computer hardware, firmware, software, and/or combinations thereof. These various implementations may include: being implemented in one or more computer programs that are executed and/or interpreted on a programmable system including at least one programmable processor, which may be a special purpose or general purpose programmable processor that receive data and instructions from a storage system, at least one input device, and at least one output device, and transmit data and instructions to the storage system, the at least one input device, and the at least one output device.

The program code for implementing the method of certain embodiments of the present disclosure may be written in any combination of one or more programming languages. These program codes may be provided to a processor or controller of a general-purpose computer, a special-purpose computer, or other programmable data processing device, so that the program code, when executed by the processor or controller, implements the functions/operations specified in the flow chart and/or block diagram. The program code may be executed entirely on the machine, partially on the machine, partially on the machine and partially on a remote machine as a stand-alone software package, or entirely on a remote machine or server.

In certain embodiments of the present disclosure, a machine-readable medium may be a tangible medium that may contain or store a program for use by or in conjunction with an instruction execution system, device, or equipment. A machine-readable medium may be a machine-readable signal medium or a machine-readable storage medium. A machine-readable medium may include, but is not limited to, an electronic, magnetic, optical, electromagnetic, infrared, or semiconductor system, device, or device, or any suitable combination of the foregoing. An example of a machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

To provide interaction with a user, the systems and techniques described herein may be implemented on a computer having: a display device (for example, a CRT (cathode ray tube) or LCD (liquid crystal display) monitor) for displaying information to the user; and a keyboard and pointing device (for example, a mouse or trackball) through which the user provides input to the computer. Other types of devices may also be used to provide interaction with the user; for example, the feedback provided to the user may be any form of sensory feedback (for example, visual feedback, auditory feedback, or tactile feedback); and input from the user may be received in any form (including acoustic input, voice input, or tactile input).

The systems and techniques described herein may be implemented in a computing system that includes back-end components (for example, a data server), or a computing system that includes middleware components (for example, an application server), or a computing system that includes front-end components (for example, a user computer with a graphical user interface or a web browser through which a user may interact with implementations of the systems and techniques described herein), or a computing system that includes any combination of such back-end components, middleware components, or front-end components. The components of the system may be interconnected by any form or medium of digital data communication (for example, a communication network). Examples of communication networks include: a local area network (LAN), a wide area network (WAN), and the Internet.

A computer system may include a client and a server. The client and the server are generally remote from each other and usually interact through a communication network. The relationship between the client and the server is generated by computer programs running on corresponding computers and having a client-server relationship with each other. The server may be a cloud server, a server of a distributed system, or a server combined with a blockchain.

In certain embodiments, various forms of the process described and/or shown herein may be used to reorder, add or delete steps. For example, the steps recorded in certain embodiments of the present disclosure may be executed in parallel, sequentially, or in different orders, as long as the desired results of the technical solution may be achieved, and scope of such arrangement does not have to be limited.

When applicable and unless otherwise clearly defined, the terms “first” and “second” are used for descriptive purposes only and are not to be understood as indicating or implying relative importance or implicitly indicating the number of technical features indicated. Therefore, the features defined as “first” and “second” may explicitly or implicitly include at least one of the features. When applicable and unless otherwise clearly defined, the term “multiple” refers to two or more.

The description reflects certain implementation of the present disclosure, but the protection scope of the present disclosure is not limited to the description. Any technician familiar with the technical field may think of changes or replacements within the technical scope disclosed in the present disclosure, which should be covered within the protection scope of the present disclosure. Therefore, the protection scope of the present disclosure shall be based on the protection scope of the claims.

What is claimed is:

1. A method of controlling a target virtual object, the method comprising:
in response to determining a target virtual object existing in a target interactive interface, identifying a user's gesture action;
in response to determining the gesture action is a predetermined action formed between a user's hand and a physical object and satisfies a predetermined time condition, associating the target virtual object with the physical object; and
driving the target virtual object based on the association result and the user's operation behavior on the physical object.

2. The method of claim 1, wherein identifying the user's gesture action includes one or more of:
collecting video data via a camera, and analyzing action information related to the user's hand and the physical object in the video data to determine the user's gesture action; and
collecting posture change data of the user's hand via an inertial sensor, and determining the user's gesture action based on the posture change data.

3. The method of claim 1, wherein the predetermined action includes one or more of: grabbing, holding, lifting, sliding, overhanging, pushing, and hitting.

4. The method of claim 1, wherein associating the target virtual object with the physical object includes:
respectively obtaining first posture data of the physical object and second posture data of the target virtual object;
establishing a mapping relationship between the physical object and the target virtual object based on the first posture data and the second posture data; and
based on the mapping relationship, mapping the target virtual object as an associated object of the physical object in the virtual environment.

5. The method of claim 1, wherein driving the target virtual object includes:
obtaining a motion offset in response to the user's operation on the physical object; and
driving the target virtual object to move according to the motion offset.

6. The method of claim 5, wherein the user's operation on the physical object includes one or more of rotating and sliding; wherein the motion offset includes one or more of:
three-axis rotation angle information of the user's gesture;
three-axis rotation angle information of the physical object; and
rotation angle change information of the target virtual object relative to a starting moment.

7. The method of claim 1, wherein the user's operation on the physical object includes:
detecting a touch on an inertial sensor;
generating a preset instruction, employed to use a current moment as a starting moment and determine a rotation angle of the target virtual object as a starting rotation angle.

8. The method of claim 1, further comprising:
prompting the user to adjust a holding posture between the user's hand and the physical object to obtain an adjusted physical object; and
associating the target virtual object with the adjusted physical object.

9. The method of claim 1, further comprising:
detecting there is no contact point between the user and the physical object, terminating control of the target virtual object; or
detecting that a displacement value of the user's hand in space exceeds a preset threshold, terminating control of the target virtual object.

10. The method of claim 1, wherein the predetermined time condition includes one or more of: predetermined action recognition results in multiple consecutive video frames within a preset time are the same; an inertial signal obtained within the preset time remains the same.

11. An electric device, comprising: a memory storing computer program instructions; and a processor coupled to the memory and configured to execute the computer program instructions and perform:
in response to determining a target virtual object existing in a target interactive interface, identifying a user's gesture action;
in response to determining the gesture action is a predetermined action formed between a user's hand and a physical object and satisfies a predetermined time condition, associating the target virtual object with the physical object; and
driving the target virtual object based on the association result and the user's operation behavior on the physical object.

12. The electric device of claim 11, wherein identifying the user's gesture action includes one or more of:
collecting video data via a camera, and analyzing action information related to the user's hand and the physical object in the video data to determine the user's gesture action; and
collecting posture change data of the user's hand via an inertial sensor, and determining the user's gesture action based on the posture change data.

13. The electric device of claim 11, wherein the predetermined action includes one or more of: grabbing, holding, lifting, sliding, overhanging, pushing, and hitting.

14. The electric device of claim 11, wherein associating the target virtual object with the physical object includes:
respectively obtaining first posture data of the physical object and second posture data of the target virtual object;
establishing a mapping relationship between the physical object and the target virtual object based on the first posture data and the second posture data; and
based on the mapping relationship, mapping the target virtual object as an associated object of the physical object in the virtual environment.

15. The electric device of claim 11, wherein driving the target virtual object includes:
obtaining a motion offset in response to the user's operation on the physical object; and
driving the target virtual object to move according to the motion offset.

16. The electric device of claim 11, wherein the user's operation on the physical object includes one or more of rotating and sliding; wherein the motion offset includes one or more of:
three-axis rotation angle information of the user's gesture;
three-axis rotation angle information of the physical object; and
rotation angle change information of the target virtual object relative to an starting moment.

17. The electric device of claim 11, wherein the user's operation on the physical object includes:
detecting a touch on an inertial sensor;
generating a preset instruction, employed to use a current moment as a starting moment and determine a rotation angle of the target virtual object as a starting rotation angle.

18. The electric device of claim 11, wherein the processor is configured to perform:
prompting the user to adjust a holding posture between the user's hand and the physical object to obtain an adjusted physical object; and
associating the target virtual object with the adjusted physical object.

19. The electric device of claim 11, wherein the processor is configured to perform:
detecting there is no contact point between the user and the physical object, terminating control of the target virtual object; or
detecting that a displacement value of the user's hand in space exceeds a preset threshold, terminating control of the target virtual object.

20. A non-transitory computer-readable storage medium storing computer program instructions executable by at least one processor to perform:
in response to determining a target virtual object existing in a target interactive interface, identifying a user's gesture action;
in response to determining the gesture action is a predetermined action formed between a user's hand and a physical object and satisfies a predetermined time condition, associating the target virtual object with the physical object; and
driving the target virtual object based on the association result and the user's operation behavior on the physical object.
